(19) United States
(12) Patent Application Publication
(10) Pub. No.: US 2010/0319397 A1
(43) Pub. Date: Dec. 23, 2010

(54) CRYOGENIC PRE-CONDENSING METHOD AND APPARATUS

(76) Inventors: Ron C. LEE, Bloomsbury, NJ (US); Stefan Wolf, Haar (DE); Hans-Rudolf Himmen, Haimhausen (DE)

Correspondence Address: The BOC Group, Inc., 575 MOUNTAIN AVENUE, MURRAY HILL, NJ, 07974-2082, US

(21) Appl. No.: 12/489,955

(22) Filed: Jun. 23, 2009

(51) Int. Cl. B01D 5/00; F25J 3/04

(52) U.S. Cl. 62/640; 62/93; 62/903

(57) ABSTRACT

A method and apparatus for removing components from a gas stream by feeding the gas stream into a pre-condensation unit to produce a gas stream at a lower intermediate temperature and feeding this intermediate temperature gas stream into a cryogenic condensation unit where a lower predetermined final temperature is achieved. This final temperature gas stream is directed back to the pre-condensation unit to assist in cooling the gas stream entering this unit.

### BACKGROUND OF THE INVENTION

The present invention provides for a method and apparatus to pre-condense components including water from a process gas stream. Liquid nitrogen is employed combined with cold process gas from a downstream processing unit to minimize the formation of ice. The method also provides for means to defrost excess ice accumulation while continuing at least partial pre-condensation.

Vent streams from many process plants often contain volatile organic compounds (VOCs) or similar compounds and frequently water. These VOCs must typically be removed from the vent stream to an acceptable degree by such abatement technologies as thermal destruction, adsorption or cryogenic condensation The cryogenic condensation approach for removing VOCs from vent stream is a well established technology that relies on reducing the temperature of the process gas stream and causing the VOCs to condense as a liquid. This condensed liquid may be collected and re-used or otherwise disposed of in an environmentally acceptable manner. Typical process gas outlet temperatures are in the range of −60° C. to −100° C.

There are limitations that reduce the efficiency and practicality of cryogenic systems. Among these limitations are the potential for freezing some VOCs or other components and the inefficiency of venting a very cold purified process gas which is typically air or nitrogen. The most notable component that can cause a freezing concern is water. A know method for reducing the amount of freezing, especially of water, that can occur in the main cryogenic condenser is to use a pre-condenser. This pre-condenser may employ a chilled water or brine refrigerant, but that adds complexity and cost to the overall system. Alternatively, the cold process gas has refrigeration value but there may be insufficient refrigeration value to accomplish the desired amount of pre-condensing. Liquid nitrogen may be injected and mixed with the cold process gas to increase its cooling potential however, that can cause unacceptable dilution of the vent gas and there is still a limit to the amount of additional cooling that may be achieved. Alternatively, liquid nitrogen may be used to indirectly cool the cold process gas prior to the pre-condenser, which avoids the unacceptable dilution but there remains a limit to the amount of additional cooling that can be achieved. For example, if the cold process gas is at a temperature of −90° C., then it can only be cooled further to about −180° C. while still remaining a cold gas coolant. Even as a cold gas coolant there can be problems with freezing in the pre-condenser at very low coolant temperature.

### SUMMARY OF THE INVENTION

The present invention is able to minimize these limitations by employing a novel heat exchanger arrangement. The present invention enables pre-condensing with full recovery of the cooling potential of the cold process gas from a main condenser. Further the present invention provides the capability of adding essentially unlimited additional cryogenic cooling capability, limited only by surface area, necessary to achieve the desired amount of pre-condensing through the use of a co-current “tube in tube” approach.

The present invention also provides means to advantageously use the formation of ice within the pre-condenser to perform the pre-condensing Ice formation can also be minimized. The warm process gas can be used periodically to melt excessive ice formation while simultaneously continuing to provide at least partial pre-condensing.

The present invention will accomplish pre-condensing with a full recovery of the cooling potential of the cold process gas from a main condenser. The use of a co-current “tube in tube” pre-condensation unit will allow for adding essentially unlimited additional cryogenic cooling capability to the desired amount of pre-condensing. The present invention further uses the formation of ice within the pre-condenser advantageously to perform the pre-condensing. Further, the present invention provides a means to minimize excessive ice formation as well as allowing the warm process gas to periodically melt the excessive ice formation while simultaneously continuing to provide at least partial pre-condensing.

In a first embodiment of the present invention there is disclosed a method for pre-condensing components from a gas stream comprising the steps;
directing the gas stream into a pre-condensation unit wherein it is cooled to a pre-determined intermediate temperature;
directing the gas stream at an intermediate temperature to a cryogenic condensation unit wherein the gas stream at an intermediate temperature is cooled to a final predetermined temperature; and
directing the gas stream at a final predetermined temperature to the pre-condensation unit.

The process gas stream can be from an industrial process that contains components that need be removed the from the process gas stream. The components that are condensed out of the system include volatile organic compounds and water and are removed as condensate from both the pre-condensation unit and the cryogenic condensation unit.

Liquid nitrogen is employed to provide cooling to both the pre-condensation unit and the cryogenic condensation unit.

The pre-condensation unit is preferably a tube in tube heat exchanger, although other heat exchanger designs can be employed. The pre-condensation unit needs means for inputting a process gas stream to be cooled and an output means where the gas will be at a lower intermediate temperature when it leaves the pre-condensation unit. The lower intermediate temperature is considered versus the temperature of the process gas stream when it enters the pre-condensation unit and when it exits the primary cryogenic condensing unit.

The invention further comprises an apparatus for pre-condensing components from a gas stream comprising a pre-condensation unit; a cryogenic condensation unit; and at least one means for fluidly connecting the pre-condensation unit and the cryogenic condensation unit.

Preferably the pre-condensation unit is a tube in tube heat exchanger which has means for inputting a process gas a means for outputting a gas stream at intermediate temperature. The tube in tube heat exchanger will also have means for inputting liquid nitrogen and means for outputting exhaust nitrogen gas. The tube in tube heat exchanger will also have means for venting warm gas.

The tube in tube heat exchanger will also have means for inputting the gas stream at a predetermined final temperature. The tube in tube heat exchanger contains refrigeration tubes comprising outer and inner cooling tubes which are in thermal contact. Liquid nitrogen flows through the inner cooling tubes. Additionally a thermal shield may be disposed on at least a portion of the inner cooling tubes. The gas stream at final predetermined temperature flows through an annular space in the tube in tube heat exchanger.

Preferably the flows of the liquid nitrogen and the gas stream at a predetermined final temperature will be co-current and their flows being counter-current against the process gas stream.

### BRIEF DESCRIPTION OF THE DRAWINGS

FIG. 1 is a schematic of the pre-condensing process of the present invention.

FIG. 2 is a schematic of the pre-condenser unit, tube in tube heat exchanger.

### DETAILED DESCRIPTION OF THE INVENTION

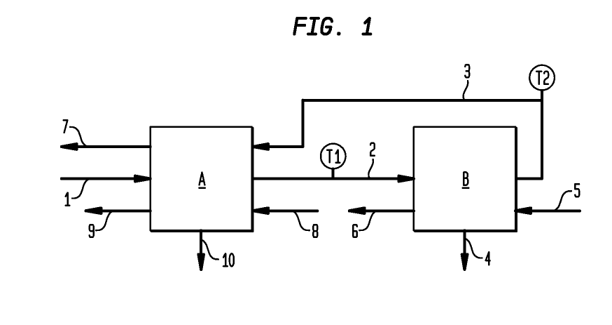

FIG. 1 is a schematic illustration of the process gas and liquid nitrogen flows associated with a pre-condenser and primary cryogenic condenser operating in accordance with the present invention. The incoming process gas stream 1 is shown entering the pre-condenser unit A where it is cooled to a predetermined intermediate temperature T1 using a combination of economized cold process gas 3 from the primary cryogenic condenser unit B and additional liquid nitrogen 8. The liquid condensed is separated and removed from the pre-condenser unit through line 10, and the intermediate process gas 2 at temperature T1 is fed to the primary cryogenic condenser unit B. The primary cryogenic condenser unit B introduces further cryogenic cooling using liquid nitrogen through line 5 to cool the process gas stream to a final predetermined temperature T2. T2 is at a temperature less than T1 which is less than the temperature of the process gas stream when it is inputted into the pre-condenser unit. T2 is preferably about −40° C. to about −150° C. The liquid nitrogen 5 is preferably converted into a cold nitrogen gas stream prior to cooling the intermediate process gas from line 2 through indirect heat exchange. Further condensate is removed via line 4 from the primary cryogenic condenser, and the purified cold process gas at temperature T2 is fed back through line 3 into the pre-condenser unit A as shown. After the cold process gas stream has provided cooling to the pre-condenser, it is vented as a warmed process gas 7 to the atmosphere.

There may be any number of additional process operations that occur upstream, downstream or between the two condensers shown in FIG. 1. This may include additional upstream pre-condensers or heat exchangers, and further downstream process conditioning units such as adsorption beds. There may be intervening cryogenic operations including between the pre-condenser and primary condenser, or the primary condenser may include multiple heat exchangers. There may be multiple primary condensers, and multiple pre-condensers configured for example to alternate in operation to enable the defrosting operations.

Additional active defrosting mechanisms, including electric heaters or warm gas flows may be implemented in both the pre-condenser and primary condenser.

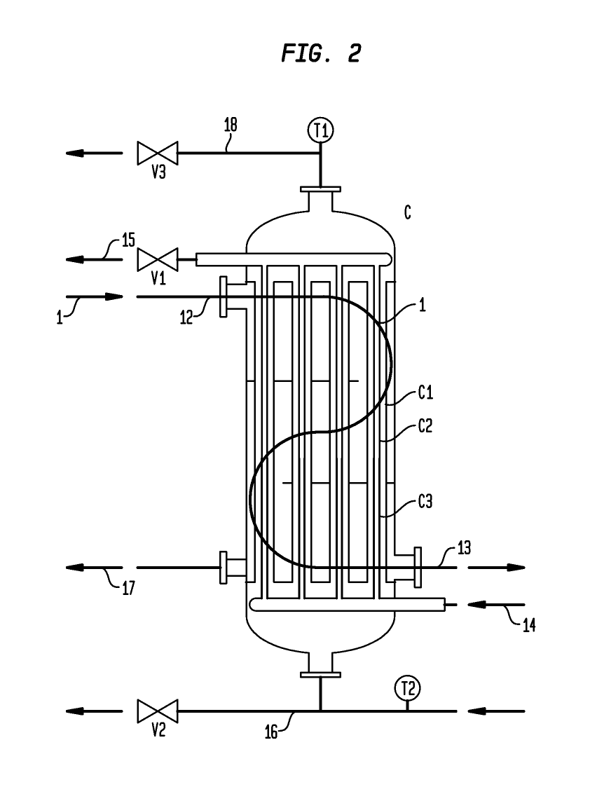

FIG. 2 is a more detailed representation of the pre-condenser of the present invention illustrating the features described with respect to FIG. 1. The overall arrangement is a traditional shell and tube heat exchanger C where the process gas inlet 12 is cooled on the shell side by outer refrigeration tubes C1. The outer refrigeration tubes C1 will generally operate below the freezing point of some of the components, which in the present process is expected to be water which freezes at about 0° C. Therefore, it is expected ice will build on the outer surface of the refrigeration tubes until a thermal equilibrium is achieved. When thermal equilibrium is reached, the outer surface of the refrigeration tubes will mostly be coated with ice and be at temperatures close to 0° C., and further condensation of water will continue based on the temperature difference between the process gas and the ice surface temperature. It is expected that the predetermined intermediate process gas temperature will be selected to be somewhat above the expected ice surface temperature. For the situation of water, an expected value for T1 is about −10° C. to about 10° C. with a temperature of about 1° C. to about 5° C. preferred.

The process gas stream 1 from FIG. 1 enters the pre-condensing unit C through inlet 12 and as shown in FIG. 2 follows an “S” shaped path through the heat exchanger to exit at temperature T1 through outlet 13. The condensate indicated as line 10 in FIG. 1 will exit the heat exchanger through condensate drain 17.

The refrigeration tubes employ a “tube in tube” arrangement which has co-current flow of liquid nitrogen in the inner cooling tube C2 and cold process gas in the annular space. The co-current arrangement of the two coolants, counter-current to the shell side process gas, helps to ensure the optimum thermal utilization of the coolants by venting these at as warm a temperature as possible.

There are two advantages to the “tube in tube” arrangement. First, the amount of additional cryogenic cooling which may be provided is limited only by the surface area of the refrigeration tubes, allowing the ice layer that is expected to form on the outer surface. Second, the annular space containing the cold process gas separates the extreme low temperature of liquid nitrogen from being directly exposed to the process gas on the shell side. This serves to reduce the rate and thickness of the ice growth on the outer surface. In general, the ice will tend to accumulate more at the cold end of the heat exchanger C. While optional, the thickness of the ice layer in the cold region of the heat exchanger can be minimized by introducing a suitable thermal shield of insulation C3 on the inner cooling tube in the cold region of the heat exchanger. This optional thermal shield has the added advantage of allowing the cold process gas to provide refrigeration before being introduced to the additional refrigeration effect of the liquid nitrogen. This reduces both the outer ice layer growth in the cold region, as well as potential freezing of remaining uncondensed VOCs contained in the cold process gas.

The pre-determined temperature T1 of the intermediate process gas exiting the pre-condenser is maintained by adjusting the flow rate of liquid nitrogen 14 through to nitrogen exhaust 15 using valve V1. This assumes the normal circumstance where the amount of cooling required is greater than is available from the cold process gas alone entering the heat exchanger through line 16.

It is expected that during the usual operation the expected growth of ice on the outer cooling tubes will achieve an equilibrium that can be accommodated by the design of the heat exchanger. The rate of condensation becomes equal to the rate of heat transfer through an ice layer having an outer surface at a temperature of about 0° C. However, during prolonged operation or certain operating conditions the ice layer may grow beyond what can be accommodated. In that case, a variety of passive defrost techniques are envisioned by the present invention. Once an ice layer has formed on the outer tubes it is possible to turn off either or both the liquid nitrogen 14 and cold process gas 16 without having a significant impact on the pre-condensing of the inlet process gas 12. However, with either or both of these cooling sources turned off, the rate of ice formation will generally reverse and begin to melt. The mechanism for turning off or reducing the liquid nitrogen flow 14 is by using valve V1, while the mechanism for turning off the cold process gas coolant 16 is by closing outlet valve V3 and opening bypass valve V2. By turning off the cold process gas 16, thermal separation will continue to be proved between the inner and outer coolant tubes. It is anticipated that turning off or reducing the flow of liquid nitrogen 14 will generally be adequate to cause passive defrost. It is further anticipated that the normal operation of the overall cryogenic condensation system will not generally be adversely impacted by a modest rise of temperature T1 during the period of passive defrost.

The heat exchanger arrangement may be of a variety of designs, including alternatives to the traditional shell and tube arrangement. The tube in tube arrangement may be effected by a variety of arrangements that could include non-circular geometries or multiple inner tubes.

A variety of process gas compositions either with or without water are possible. Freezing in the pre-condenser may not always occur and may occur at a variety of characteristic temperatures.

The operating pressures may be other than atmospheric and the process gas vent 18 may or may not be to the atmosphere. For example, the overall system may be part of an internal recycle system.

The flows of the two coolants, cold process gas and liquid nitrogen may be co-current (12 to 13) as shown in FIG. 2 or counter current. The coolant flows may be either counter-current with the shell side process gas (14 to 15) as shown in FIG. 2 or co-current.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what we claim is:

1. A method for pre-condensing components from a gas stream comprising the steps:
directing said gas stream into a pre-condensation unit wherein it is cooled to a pre-determined intermediate temperature;
directing said gas stream at an intermediate temperature to a cryogenic condensation unit wherein said gas stream at an intermediate temperature is cooled to a final predetermined temperature; and
directing said gas stream at a final predetermined temperature to said pre-condensation unit.

2. The method as claimed in claim 1 wherein said components are selected from the group consisting of volatile organic compounds and water.

3. The method as claimed in claim 1 wherein said gas stream is a vent stream from an industrial process.

4. The method as claimed in claim 1 wherein liquid nitrogen provides cooling to said pre-condensation unit.

5. The method as claimed in claim 1 wherein said components are removed as condensate from said pre-condensation unit.

6. The method as claimed in claim 1 wherein liquid nitrogen provides cooling to said cryogenic condensation unit.

7. The method as claimed in claim 1 wherein said components are removed as condensate from said cryogenic condensation unit.

8. The method as claimed in claim 1 wherein said gas stream at a final predetermined temperature provides cooling to said pre-condensation unit.

9. The method as claimed in claim 1 wherein said gas stream at a final predetermined temperature is warmed in said pre-condensation unit and vented from said pre-condensation unit.

10. The method as claimed in claim 1 wherein said intermediate temperature is about −10° C. to about 10° C.

11. The method as claimed in claim 1 wherein said final predetermined temperature is about −40° C. to about −150° C.

12. The method as claimed in claim 1 wherein said pre-condensation unit is a tube in tube heat exchanger.

13. The method as claimed in claim 12 wherein said tube in tube heat exchanger comprises means for inputting said process gas and means for outputting said gas stream at an intermediate temperature.

14. The method as claimed in claim 12 wherein said tube in tube heat exchanger has means for inputting liquid nitrogen and means for outputting exhaust nitrogen gas.

15. The method as claimed in 12 wherein said tube in tube heat exchanger comprises means for venting warm gas.

16. The method as claimed in claim 12 wherein said tube in tube heat exchanger comprises means for inputting said gas stream at a predetermined final temperature.

17. The method as claimed in claim 12 wherein said tube in tube heat exchanger contains refrigeration tubes comprising outer and inner cooling tubes.

18. The method as claimed in claim 17 wherein said outer and inner cooling tubes are in thermal contact.

19. The method as claimed in claim 17 further comprising a thermal shield disposed on top of at least a portion of said inner cooling tubes.

20. The method as claimed in claim 12 wherein liquid nitrogen flows through said inner cooling tubes.

21. The method as claimed in claim 12 wherein said gas stream at a final predetermined temperature flows through an annular space in said tube in tube heat exchanger.

22. The method as claimed in claim 21 wherein said liquid nitrogen and said gas stream at a final predetermined temperature are in a co-current flow with each other.

23. The method as claimed in claim 13 wherein said process gas flows through said tube in tube heat exchanger on its shell side.

24. The method as claimed in claim 23 wherein said liquid nitrogen and said gas stream at a final predetermined temperature are in counter-current flow with said process gas.

25. An apparatus for pre-condensing components from a gas stream comprising a pre-condensation unit; a cryogenic condensation unit; and at least one means for fluidly connecting said pre-condensation unit and said cryogenic condensation unit.

26. The apparatus as claimed in claim 25 wherein said pre-condensation unit is a tube in tube heat exchanger.

27. The apparatus as claimed in claim 26 wherein said tube in tube heat exchanger comprises means for inputting said process gas and means for outputting said gas stream at an intermediate temperature.

28. The apparatus as claimed in claim 26 wherein said tube in tube heat exchanger has means for inputting liquid nitrogen and means for outputting exhaust nitrogen gas.

29. The apparatus as claimed in claim 26 wherein said tube in tube heat exchanger comprises means for venting warm gas.

30. The apparatus as claimed in claim 26 wherein said tube in tube heat exchanger comprises means for inputting said gas stream at a predetermined final temperature.

31. The apparatus as claimed in claim 26 wherein said tube in tube heat exchanger contains refrigeration tubes comprising outer and inner cooling tubes.

32. The apparatus as claimed in claim 31 wherein said outer and inner cooling tubes are in thermal contact.

33. The apparatus as claimed in claim 31 further comprising a thermal shield disposed on top of at least a portion of said inner cooling tubes.

34. The apparatus as claimed in claim 31 wherein liquid nitrogen flows through said inner cooling tubes.

35. The apparatus as claimed in claim 34 wherein said gas stream at a final predetermined temperature flows through an annular space in said tube in tube heat exchanger.

36. The apparatus as claimed in claim 36 wherein said liquid nitrogen and said gas stream at a final predetermined temperature are in a co-current flow with each other.

37. The apparatus as claimed in claim 26 wherein said process gas flows through said tube in tube heat exchanger on its shell side.

38. The apparatus as claimed in claim 37 wherein said liquid nitrogen and said gas stream at a final predetermined temperature are in counter-current flow with said process gas.

39. The apparatus as claimed in claim 26 wherein said cryogenic condensation unit comprises liquid nitrogen input means and gaseous nitrogen exhaust means.
